(19) United States
(12) Patent Application Publication
(10) Pub. No.: US 2011/0078802 A1
(43) Pub. Date: Mar. 31, 2011

(54) DISPLAY DEVICE, DRIVE RECORDER, DISPLAY METHOD AND COMPUTER-READABLE MEDIUM

(75) Inventors: Kohhei ONO, Kobe-shi (JP); Kazunari NAKAJIMA, Kobe-shi (JP)

(73) Assignee: FUJITSU TEN LIMITED, KOBE-SHI (JP)

(21) Appl. No.: 12/891,100

(22) Filed: Sep. 27, 2010

(30) Foreign Application Priority Data
Sep. 30, 2009 (JP) 2009-228216

(51) Int. Cl. G06F 21/24

(52) U.S. Cl. 726/30

(57) ABSTRACT

A display device displays data recorded in a portable recording medium by a drive recorder on a display unit. A code recording unit records a security code in the recording medium in which data is recorded by the drive recorder. A nonvolatile storage device stores a security code which is the same as the security code for use at the time of recording in the recording medium. A code acquisition unit acquires the security code from recorded contents of the recording medium in which the data is recorded by the drive recorder. A code authentication unit enables the display unit to display the data recorded in the recording medium when the security code acquired from the recording medium coincides with the security code stored in the storage device.

The disclosure of Japanese Patent Application No. 2009-228216 filed on Sep. 30, 2009, including specification, drawings and claims is incorporated herein by reference in its entirety.

### BACKGROUND

The present invention relates to a technique for handling data recorded in a portable recording medium by a drive recorder.

In the related art, a drive recorder is known which constantly photographs the outside of a vehicle or the vehicle interior by a camera mounted in the vehicle and, when an event such as an accident occurs, records images acquired before and after the occurrence of the event in a portable recording medium, such as a memory card. A drive recorder or the like is also known which records not only images but also the traveling situation of a vehicle, such as the position, speed, acceleration, and the like of the vehicle, in a recording medium, or records images representing the situations of the outside of the vehicle or the vehicle interior in a recording medium in a predetermined cycle, regardless of events.

In recent years, in companies which carry out operations by using a plurality of vehicles for commercial use, such as trucks, buses, and taxis, a drive recorder is mounted in all of the vehicles which are used to carry out operations. In such companies, data acquired by the drive recorder of each vehicle is used for investigation of the causes of an accident, analysis of the driving tendencies of the driver, and guidance regarding the safe driving of the driver.

Patent Documents 1 and 2 describe a drive recorder which constantly photographs the vicinity of a vehicle by a vehicle-mounted camera, and records an image acquired at the time of occurrence of an accident in a recording medium. Patent Documents 3 and 4 describe a drive recorder which records data representing the traveling situation, such as vehicle speed, at the time of occurrence of an accident in a recording medium.

Patent Document 1: JP-A-63-16785

Patent Document 2: JP-A-06-237463

Patent Document 3: JP-A-06-331391

Patent Document 4: JP-A-06-186061

Meanwhile, since a recording medium in which various kinds of data is recorded by a drive recorder is portable, there is no denying that the recording medium may go missing while the driver of the vehicle is working.

When a drive recorder is provided in vehicles for passenger transportation, such as buses and taxis, images for grasping privacy information of passengers such as who, when, where from, and where to are recorded by the drive recorder. In such a case, if the recording medium in which data is recorded by the drive recorder goes missing, privacy information of passengers may leak from the images recorded in the recording medium. Further, even in the case of vehicles other than buses and taxis, business information which should be secret may be recorded in a recording medium by a drive recorder, and data leakage due to missing of the recording medium may be problematic.

In order to deal with such a problem, a method is suggested in which the images recorded in the recording medium by the drive recorder are in a format for exclusive use, instead of the general format, such as PEG or MPEG, and can be displayed only by an exclusive-use application. Even with this configuration, however, if the exclusive-use application program is obtained, the images recorded in the recording medium can be easily viewed. Thus, this method is not an ultimate resolution.

### SUMMARY

It is therefore an object of at least one embodiment of the present invention to provide a technique capable of preventing data recorded by a drive recorder from leaking.

In order to achieve at least one of the above-described objects, according to a first aspect of the embodiments of the present invention, there is provided a display device that displays data recorded in a portable recording medium by a drive recorder on a display unit, the display device comprising: a code recording unit that records a security code in the recording medium in which data is recorded by the drive recorder; a nonvolatile storage device that stores a security code which is the same as the security code for use at the time of recording in the recording medium; a code acquisition unit that acquires the security code from recorded contents of the recording medium in which the data is recorded by the drive recorder; and a code authentication unit that enables the display unit to display the data recorded in the recording medium when the security code acquired from the recording medium coincides with the security code stored in the storage device.

With this configuration, when the security code acquired from the recording medium coincides with the security code stored in the storage device, display of data recorded in the recording medium is enabled. Therefore, if the security code is not known, data recorded in the recording medium cannot be displayed, such that data recorded by the drive recorder can be prevented from leaking.

The code recording unit may record the security code in a predetermined file, and the code acquisition unit may acquire the security code from the predetermined file of the recording medium.

With this configuration, the security code is recorded in the predetermined file, and the security code is acquired from the predetermined file. Therefore, data can be prevented from leaking without requiring special processing in the drive recorder.

The predetermined file may be a setup file in which a plurality of setup parameters of the drive recorder are recorded.

With this configuration, the security code is recorded in the setup file in which a plurality of setup parameters are recorded. Therefore, the security code can be mingled with other setup parameters, and thus the presence of the security code can be hidden.

The drive recorder may embed the security code in each piece of data recorded in the recording medium, and the code acquisition unit may acquire the security code from data to be read in the recording medium in which the data is recorded.

With this configuration, the security code is embedded in each piece of data recorded in the recording medium. Therefore, the presence of the security code can be hidden.

The code recording unit may encrypt the security code and record the encrypted security code in the recording medium.

The code acquisition unit may decrypt the encrypted security code acquired from the recorded contents of the recording medium in which the data is recorded.

With this configuration, the security code is encrypted and recorded in the recording medium. Therefore, even when the presence of the security code is known, the contents of the security code can be prevented from leaking.

The display device may further comprise a recording unit that receives a change of the security code from a user and stores both a security code before change and a security code after change in the storage device, and the code authentication unit may enable the display unit to display the data recorded in the recording medium even when the security code acquired from the recording medium coincides with the security code before change stored in the storage device.

With this configuration, even when the security code is changed, the security code before change is also stored in the storage device. Therefore, data associated with the security code before change can be displayed.

The number of security codes before change for use in comparison with the security code acquired from the recording medium by the code authentication unit may be limited to a predetermined number.

With this configuration, the number of security codes before change for authentication is limited. Therefore, the possibility of data leakage due to accidental coincidence and the like can be reduced.

The display device may further comprise a receiving unit that receives an input of a security code by the user when the security code acquired from the recording medium does not coincide with the security code stored in the storage device, and the code authentication unit may enable the display unit to display the data recorded in the recording medium even when the security code acquired from the recording medium coincides with the security code received by the receiving unit.

With this configuration, even when the security code is changed, the security code before change is input, such that data associated with the security code before change can be displayed.

According to a second aspect of the embodiments of the present invention, there is provided a drive recorder to be mounted in a vehicle, that records data regarding traveling of the vehicle in a portable recording medium, the drive recorder comprising: a reading unit that reads a security code from the recording medium in which the security code is recorded; and an embedding unit that embeds the read security code in each piece of data to be recorded in the recording medium.

With this configuration, data leakage can be prevented in units of data, not in units of recording mediums.

The drive recorder may further comprise a deletion unit that deletes the security code from the recording medium after the reading unit reads the security code from the recording medium.

With this configuration, the presence of the security code can be hidden.

According to a third aspect of the embodiments of the present invention, there is provided a method of displaying data recorded in a portable recording medium by a drive recorder on a display unit, the method comprising: recording a security code in the recording medium in which data is recorded by the drive recorder; storing a security code which is the same as the security code for use at the time of recording in the recording medium in a nonvolatile storage device; acquiring the security code from recorded contents of the recording medium in which the data is recorded by the drive recorder; and enabling the display unit to display the data recorded in the recording medium when the security code acquired from the recording medium coincides with the security code stored in the storage device.

According to a fourth aspect of the embodiments of the present invention, there is provided a computer-readable medium recording a program causing a computer to execute the method according to the third aspect of the embodiments of the present invention.

### BRIEF DESCRIPTION OF THE DRAWINGS

In the accompanying drawings:

FIG. 1 is a diagram showing the outline of a drive recorder system;

FIG. 2 is a diagram showing the configuration of a data display device;

FIG. 3 is a diagram showing the configuration of a drive recorder;

FIG. 4 is a diagram showing an example of a flow of an operation method of a memory card;

FIG. 5 is a diagram showing the storage state of data in a memory card;

FIG. 6 is a diagram showing a flow of processing for setting a security code;

FIG. 7 is a diagram showing an example of a setup dialogue;

FIG. 8 is a diagram showing a flow of recording preparation processing of a first embodiment;

FIG. 9 is a diagram showing an example of the contents of a setup file;

FIG. 10 is a diagram showing a flow of data recording processing of the first embodiment;

FIG. 11 is a diagram showing a flow of data latch processing of the first embodiment;

FIG. 12 is a diagram showing an example of a data region in a data file;

FIG. 13 is a diagram showing a flow of data latch processing of a second embodiment;

FIG. 14 is a diagram illustrating a case where a security code is encrypted;

FIG. 15 is a diagram showing a flow of processing for changing a security code of a fourth embodiment;

FIG. 16 is a diagram showing an example of a change dialogue;

FIG. 17 is a diagram showing a flow of data latch processing of the fourth embodiment;

FIG. 18 is a diagram showing an example of an input dialogue;

FIG. 19 is a diagram showing a flow of processing for changing a security code of a fifth embodiment; and

FIG. 20 is a diagram showing a flow of data latch processing of the fifth embodiment.

### DETAILED DESCRIPTION OF THE EMBODIMENTS

Hereinafter, embodiments of the invention will be described with reference to the drawings.

### 1. First Embodiment

<1-1. Configuration>

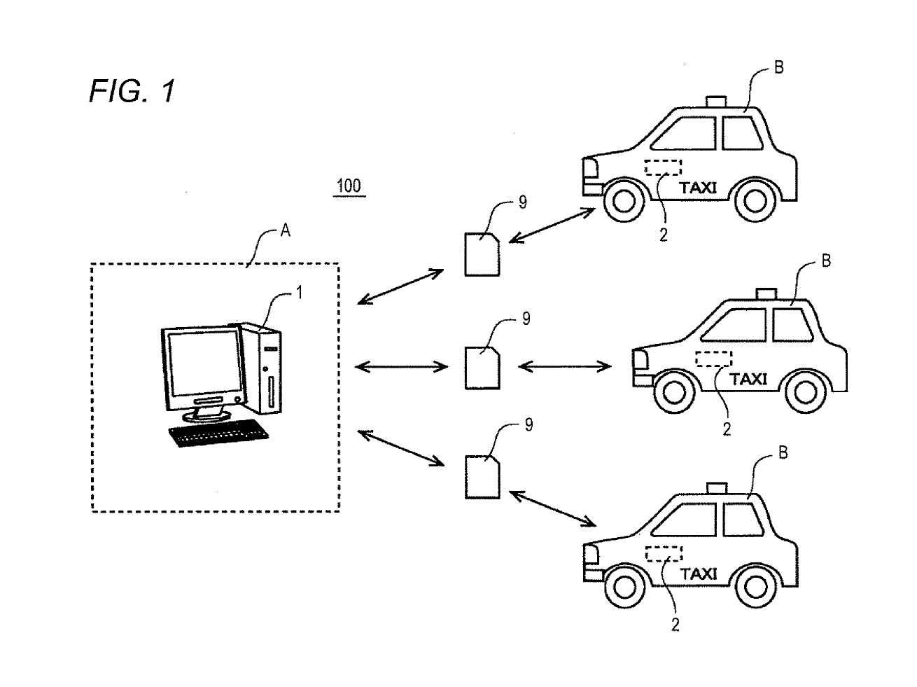

FIG. 1 is a diagram showing the outline of a drive recorder system 100 which includes a data display device 1 and a drive recorder 2. The drive recorder system 100 is used in a company which carries out operations by using a plurality of vehicles for commercial use, such as trucks, buses, and taxis. In this embodiment, description will be provided for a case where the drive recorder system 100 is used in a company which carries out operations by using taxis.

In this company, operations are carried out by using a plurality of vehicles B, including taxis, and the drive recorder 2 is mounted in each of the plurality of vehicles B. In an establishment A which manages a plurality of vehicles B, a data display device 1 is provided which manages and displays data recorded by the drive recorder 2. For data exchange between the data display device 1 and the drive recorder 2, a memory card 9 which is a portable recording medium is used. A flash memory which is a nonvolatile semiconductor memory is incorporated into the memory card 9.

The drive recorder 2 records various kinds of data regarding the operation of a vehicle B, in which the data recorder 2 is mounted, in the memory card 9. Specifically, if a certain event such as an accident occurs during the operation of the vehicle B, the drive recorder 2 records motion image data or sound data before and after the occurrence of the event. The drive recorder 2 also records operation data representing the traveling situation of the vehicle B, such as the position, speed, and acceleration of the vehicle, in a predetermined cycle. The drive recorder 2 also records image data and sound data representing the situations outside or inside the vehicle in a predetermined cycle as constantly recorded data, regardless of events.

Data which is recorded in the memory card 9 by the drive recorder 2 in each of a plurality of vehicles B is latched into the data display device 1 for each single operation of the vehicle B. The data display device 1 reads data recorded in the memory card 9 by the drive recorder 2 and records data in an internal nonvolatile storage device. Thus, data recorded by a plurality of vehicles B is collected in the data display device 1. In this description, the term “single operation” means that the vehicle B departs from the establishment A and comes back to the establishment A.

<1-2. Configuration of Data Display Device>

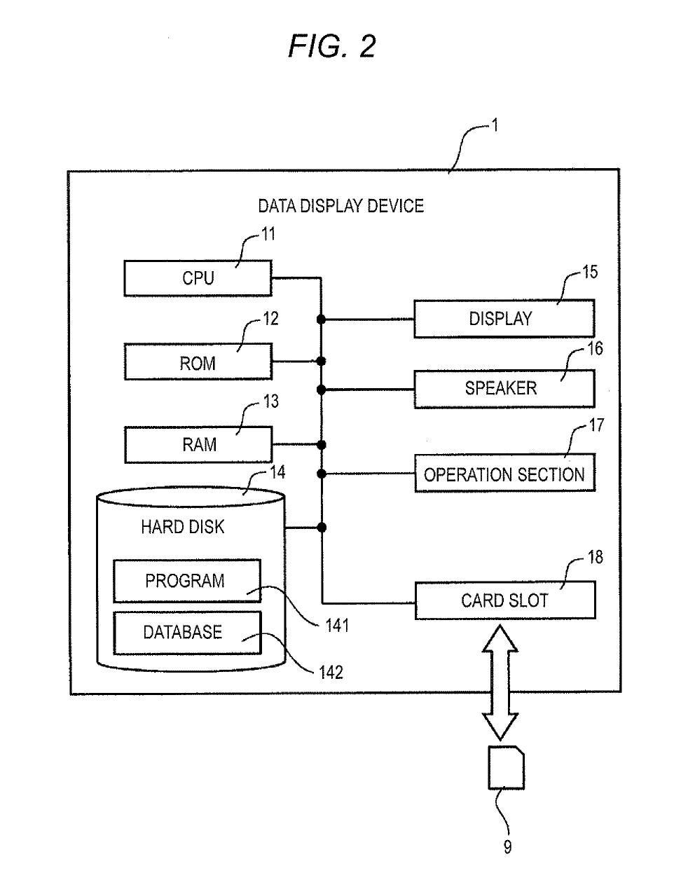

FIG. 2 is a diagram showing the configuration of the data display device 1. The hardware configuration of the data display device I is the same as the general computer. Specifically, the data display device 1 includes a CPU 11 which carries out various kinds of arithmetic processing, a ROM 12 which stores a basic program, a RAM 13 which serves as a work area of arithmetic processing, a hard disk 14 which is a nonvolatile storage device, a display 15 which performs various kinds of display, a speaker 16 which outputs sound, and an operation section 17 which is constituted by a keyboard and a mouse to be operated by the user. The data display device 1 is provided with a card slot 18 into which the memory card 9 is removably loaded. The card slot 18 reads data from the loaded memory card 9 or writes data in the memory card 9.

The hard disk 14 of the data display device 1 stores various programs 141. The CPU 11 carries out arithmetic processing in accordance with the programs 141, such that various functions necessary for the data display device 1 are implemented. One of the functions implemented by the programs 141 is an exclusive-use application which handles data recorded by the drive recorder 2. The programs 141 are read from the recording mediums (for example, the memory card 9 and the like) in which the programs are recorded, or acquired by communication through a network, and are stored in the hard disk 14 in advance.

In the hard disk 14 of the data display device 1, a database 142 is constructed in which data recorded by the drive recorder 2 is collected. Data recorded in the memory card 9 by the drive recorder 2 is read through the card slot 18 and registered in the database 142. Data registered in the database 142 can be displayed on the display 15 as an image or output from the speaker 16 as sound by using an exclusive-use application. Data registered in the database 142 is also used in various kinds of analysis for safe driving guidance for the driver using the exclusive-use application.

<1-3. Configuration of Drive Recorder>

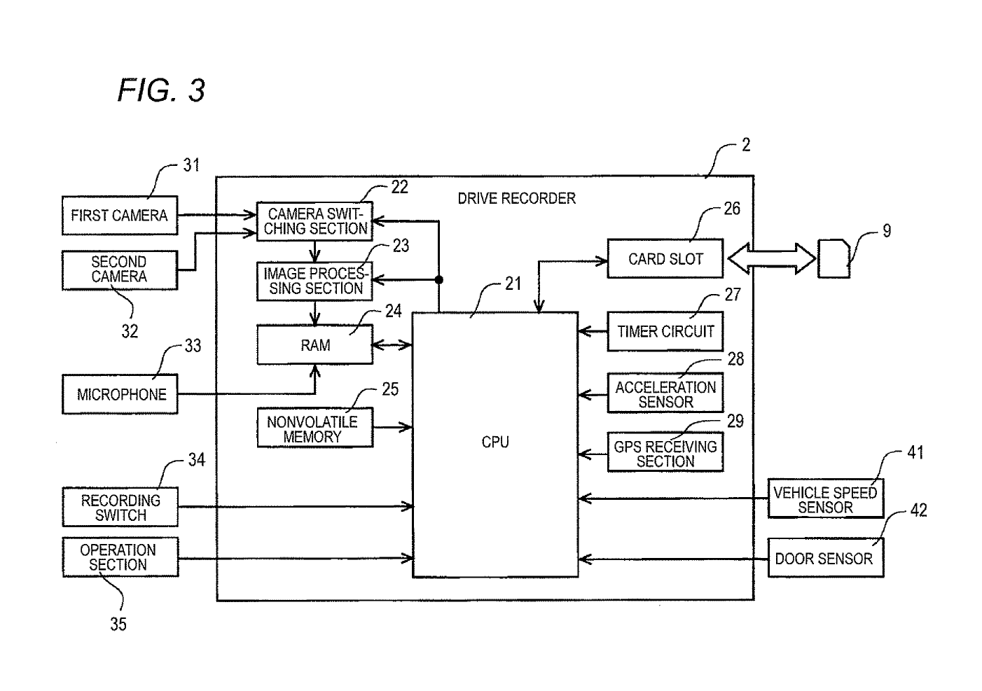

FIG. 3 is a diagram showing the configuration of the drive recorder 2. The drive recorder 2 includes a microcomputer which serves as a control section to control the entire device. Specifically, the drive recorder 2 includes a CPU 21 which carries out various kinds of arithmetic processing, a nonvolatile memory 25 which stores firmware, and a RAM 24 which serves as a work area of arithmetic processing. The CPU 21 carries out arithmetic processing in accordance with firmware stored in the nonvolatile memory 25 in advance, such that the function to control the respective sections of the drive recorder 2 is implemented. The nonvolatile memory 25 is, for example, constituted by a flash memory or the like, and stores various setup parameters and the like, in addition to firmware.

The drive recorder 2 includes two cameras 31 and 32 and a microphone 33 which are arranged at appropriate positions of the vehicle B separately from the main body portion of the drive recorder 2. Each of the two cameras 31 and 32 has a lens and an imaging element and electronically acquires image data. The first camera 31 has an optical axis which is directed forward in respect to the vehicle B outside the vehicle interior and acquires image data representing a region in front of the vehicle. The second camera 32 has an optical axis which is directed inward in respect to the vehicle interior and acquires image data representing the situation of the driver or passenger of the vehicle B. The microphone 33 collects sound outside and inside the vehicle interior to acquire sound data.

The drive recorder 2 includes a camera switching section 22 and an image processing section 23 which serve as a processing section to handle signals from the two cameras 31 and 32. The camera switching section 22 switches the signals input from the two cameras 31 and 32. The camera switching section 22 inputs the signal of image data of one of the two cameras 31 and 32 on the basis of an instruction from the CPU 21.

The image processing section 23 carries out predetermined image processing, such as A/D conversion, luminance correction, and contrast correction, for the signals input from the two cameras 31 and 32 to generate digital image data in a predetermined format, such as a JPEG format. Image data processed by the image processing section 23 is recorded in the RAM 24.

A part of the storage area of the RAM 24 is used as a ring buffer. Image data processed by the image processing section 23 and sound data acquired by the microphone 33 are constantly stored in the ring buffer. If data is stored in the last area of the ring buffer, new data is stored in the first area. Thus, in the ring buffer, the oldest data is overwritten with new data. For this reason, image data and sound data for a predetermined time are constantly stored in the RAM 24. In this embodiment, image data and sound data for at least 40 seconds are stored in the ring buffer.

The drive recorder 2 also includes a card slot 26, a timer circuit 27, an acceleration sensor 28, and a GPS receiving section 29.

The card slot 26 is configured such that the memory card 9 is removably loaded thereinto. The card slot 26 reads data from the loaded memory card 9 or writes data in the memory card 9. When an event such as an accident occurs, image data and sound data stored in the ring buffer of the RAM 24 are recorded in the memory card 9 loaded into the card slot 26 in accordance with an instruction of the CPU 21.

The timer circuit 27 generates a signal corresponding to the time at that point of time and outputs the signal to the CPU 21. The timer circuit 27 has an internal battery and, even when power is not supplied from the outside, operates to measure an accurate time.

The acceleration sensor 28 detects acceleration representing the magnitude of an impact to the vehicle B in units of gravity acceleration G. The acceleration sensor 28 detects the magnitude of acceleration according to three or two orthogonal axes and outputs the magnitude to the CPU 21.

The GPS receiving section 29 receives signals from a plurality of GPS satellites and acquires information regarding the position of the vehicle B at that point of time. The GPS receiving section 29 acquires terrestrial position information expressed by latitude and longitude and outputs the acquired position information to the CPU 21.

The drive recorder 2 also includes a recording switch 34 and an operation section 35 which serve as a member to receive an instruction from the user (mainly, the driver of the vehicle B). These sections are arranged at appropriate positions of the vehicle B, such as the vicinity of the handle, separately from the main body portion of the drive recorder 2, such that the user can easily operate the sections.

The recording switch 34 is a switch which receives a recording instruction of motion image data in the memory card 9. In a situation where no accident occurs, the user presses the recording switch 34 to record motion image data in the memory card 9 with a desired timing. The operation section 35 includes a plurality of buttons and receives input regarding various settings from the user. The contents of operations by the user are input to the CPU 21 as signals.

The drive recorder 2 is connected to a vehicle speed sensor 41 and a door sensor 42 which are arranged in the vehicle B. The vehicle speed sensor 41 detects the traveling speed (km/h) of the vehicle B at that point of time and outputs the detected traveling speed to the CPU 21. The door sensor 42 is provided in any door of the vehicle B to output a signal indicating the open/closed state of the door to the CPU 21. The door sensor 42 is, for example, provided in a door of a rear seat side where the passenger of the vehicle B, such as a taxi, gets into or out.

<1-4. Memory Card>

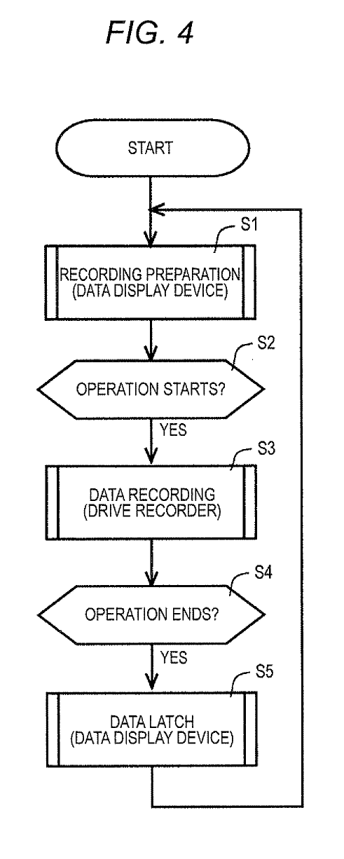

Next, an operation method of the memory card 9 in the drive recorder system 100 shown in FIG. 1 will be described. FIG. 4 is a diagram showing an example of a flow of an operation method of the memory card 9.

First, in the data display device 1, recording preparation processing is carried out as preparation for recording data of the drive recorder 2 in the memory card 9 (Step S1). The memory card 9 is formatted such that all of data are erased. Then, various setup parameters which should be set in the drive recorder 2 are recorded in the memory card 9. At this time, a security code for preventing data leakage is recorded in the memory card 9, and the details thereof will be described below.

The prepared memory card 9 is loaded in the drive recorder 2 of the vehicle B. If the vehicle 13 departs from the establishment A and starts to operate (Yes in Step S2), in the drive recorder 2, data recording processing is carried out for recording various kinds of data regarding the operation of the vehicle B in the memory card 9 during the subsequent operation of the vehicle B (Step S3).

Thereafter, if the operation of the vehicle B ends and the vehicle B comes back to the establishment A (Yes in Step S4), the memory card 9 is removed from the drive recorder 2 and loaded into the data display device 1. Then, in the data display device 1, data latch processing is carried out for latching data recorded in the memory card 9 (Step S5). Specifically, data recorded in the memory card 9 is read, converted in a predetermined format, and recorded in the database 142 of the hard disk 14 by the function of the exclusive-use application. At this time, the security code is acquired from the recorded contents of the memory card 9, and if the security code is not a predetermined security code, the processing is interrupted. The details will be described below.

The memory card 9 from which data is latched by the data display device 1 is again subjected to the recording preparation processing and loaded into the drive recorder 2 of the vehicle B to be used to record various kinds of data regarding the operation of the vehicle B (Steps S1 to S3).

As described above, the memory card 9 is repeatedly used to record data by the drive recorder 2, and data recorded in the memory card 9 is latched to the data display device 1 for each single operation of the vehicle B. The data display device 1 carries out the data latch processing after the operations of a plurality of vehicles B belonging to the establishment A are completed.

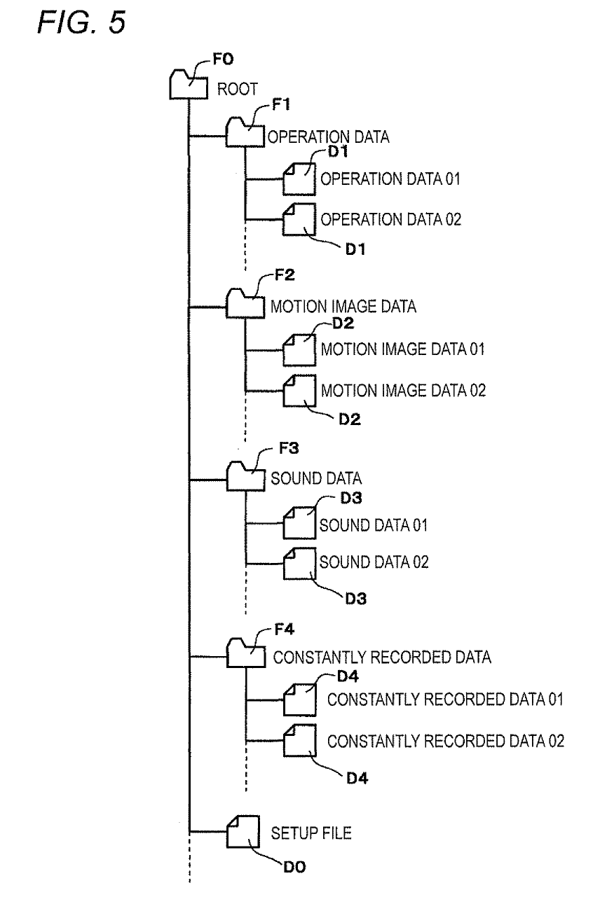

FIG. 5 is a diagram showing the storage state of data in the memory card 9. For the data storage structure in the memory card 9, a layered folder structure (layered directory structure) is used. Various kinds of data are stored in the folders, In FIG. 5, a character string next to a symbol representing a folder or data represents the name of the corresponding folder or data.

A “root” folder F0 is provided in the top layer of the layered folder structure. The “root” folder F0 stores a setup file D0 in which various setup parameters which should be set in the drive recorder 2 are recorded.

The “root” folder F0 is provided with subfolders, an “operation data” folder F1, a “motion image data” folder F2, a “sound data” folder F3, and a “constantly recorded data” folder F4.

The “operation data” folder F 1 stores files D1 of operation data representing the traveling situation of the vehicle B, such as the position, speed, and acceleration of the vehicle B during the operation of the vehicle B. The files D1 of operation data are mainly constituted by text and do not include images and sound. Operation data is additionally recorded in the same file D1 in a predetermined cycle or under a predetermined condition. When the data size of the file D1 in which operation data should be recorded exceeds a predetermined size (for example, 1 MB), a new file D1 is created, and operation data is recorded in the new file D1 The files D1 of operation data include specific data for specifying the situation of the vehicle B in which the drive recorder 2 is mounted, such as the operation start time, identification information (ID code) of the vehicle B, and identification information (ID code) of the driver, in a header region.

The “motion image data” folder F2 stores files D2 of motion image data which is obtained when a predetermined event such as an accident occurs. Motion image data is, for example, constituted by image data and sound data for 12 seconds before an event occurs and 8 seconds after the event occurs, that is, for 20 seconds in total. A single file D2 is created for each event, and motion image data regarding one event is recorded as a single file D2.

The “sound data” folder F3 stores files D3 of sound data which is obtained when a predetermined even occurs. Sound data includes sound for 12 seconds before an event occurs and 8 seconds after the event occurs, that is, for 20 seconds in total. A single file D3 is created for each event, and sound data regarding one event is recorded as a single file D3.

In the drive recorder 2, a plurality of events are supposed in advance, and it is configured to set which of motion image data and sound data is recorded for each event. For this reason, when one kind of event occurs, motion image data is recorded, and when another kind of event occurs, sound data is recorded.

The “constantly recorded data” folder F2 stores files D4 of constantly recorded data which is constituted by image data and sound data obtained in a predetermined cycle during the activation of the drive recorder 2. During the activation of the drive recorder 2, image data and sound data are additionally recorded in the file D4 as constantly recorded data in a predetermined cycle, regardless of the occurrence of an event. When the data size of the file D4 in which constantly recorded data should be recorded exceeds a predetermined size (for example, 1 GB), a new file D4 is created, and constantly recorded data is recorded in the new file D4.

<1-5. Setting of Security Code>

As described above, in the drive recorder 2, four kinds of data including operation data, motion image data, sound data, and constantly recorded data are stored in the memory card 9. The four kinds of data are all constituted by binary data and are in a special format exclusively for the drive recorder system 100, not in a general-use format (text, JPEG, MPEG, or the like) for a general computer or the like. Therefore, in order to display data recorded by the drive recorder 2 on the display or to output data from the speaker (that is, in order to confirm the contents of data recorded by the drive recorder 2), an exclusive-use application is required which is implemented by running of the program 141 in the data display device 1.

However, data recorded by the drive recorder 2 is in a format for exclusive use, but if an exclusive-use application program which can reproduce data is provided, the contents of relevant data can be confirmed. That is, if the data format is simply a format for exclusive use, when the memory card 9 goes missing, data leakage may occur. Thus, in the data display device 1 of this embodiment, in order to prevent data leakage, the security code is recorded in the memory card 9 in which data is recorded by the drive recorder 2.

The security code is, for example, constituted by four digits of numerals. The user can set an arbitrary code. The setting of the security code is carried out by using the data display device 1.

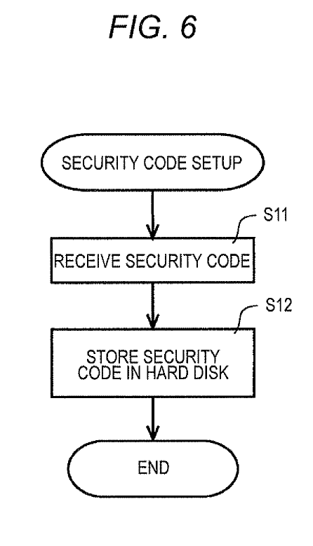

FIG. 6 is a diagram showing a flow of processing when a security code is set in the data display device 1. This processing is carried out by activating the exclusive-use application, which handles data recorded in the drive recorder 2, on the data display device 1 and carrying out a predetermined operation.

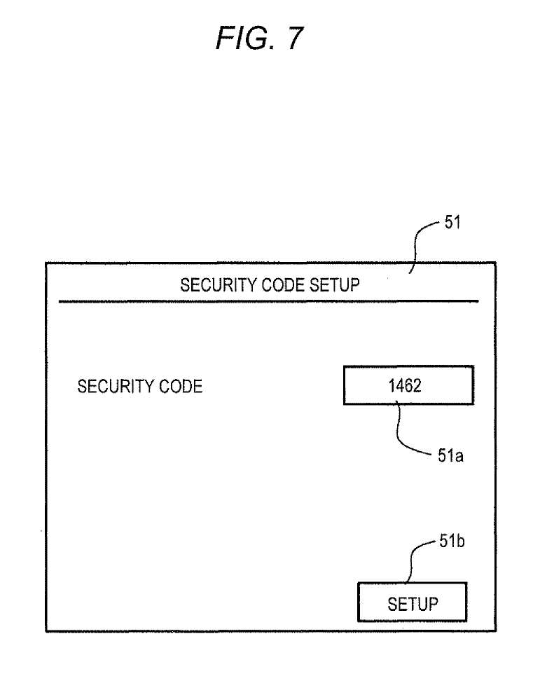

First, a setup dialogue for receiving setting of the security code is displayed on the display 15. FIG. 7 is a diagram showing an example of a setup dialogue 51. In the setup dialogue 51, a text box 51a and a setup button 51b are arranged.

The user inputs desired four digits of numerals in the text box 51a of the setup dialogue 51 and then clicks the setup button 51b. Thus, the four digits of numerals input in the text box 51a are received by the CPU 11 as the security code (Step S11). Then, the security code is recorded in the hard disk 14 of the data display device 1 (Step S12).

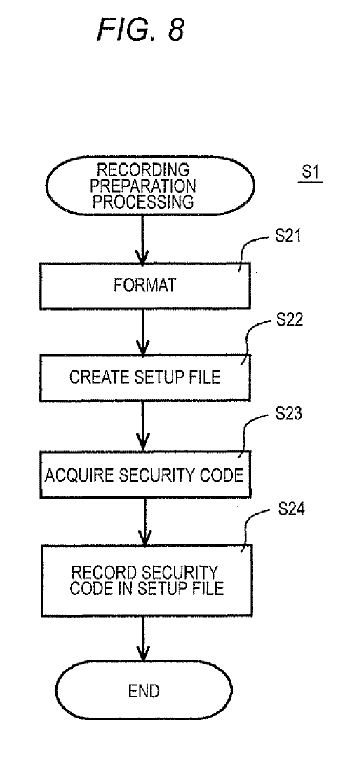

The security code set as described above is recorded in the memory card 9 during the recording preparation processing (Step Si of FIG. 4) in which the data display device 1 carries out preparation of recording in the memory card 9. FIG. 8 is a diagram showing a flow of the recording preparation processing. This processing is also carried out by activating the exclusive-use application, which handles data recorded in the drive recorder 2, on the data display device 1 and carrying out a predetermined operation. At the time of the start of this processing, it is assumed that the memory card 9 is loaded into the card slot 18.

First, the memory card 9 is formatted, such that all of data recorded in the memory card 9 are erased (Step S21).

Next, the setup file D0 is created in the memory card 9, and various setup parameters which should be set in the drive recorder 2 are recorded in the setup file D0. The setup parameters which are set by the user using the data display device 1 in advance are read from the hard disk 14 for use (Step S22).

Next, the security code set by the user is read and acquired from the hard disk 14 (Step S23). Then, the acquired security code is recorded in the setup file D0 in the memory card 9 (Step S24).

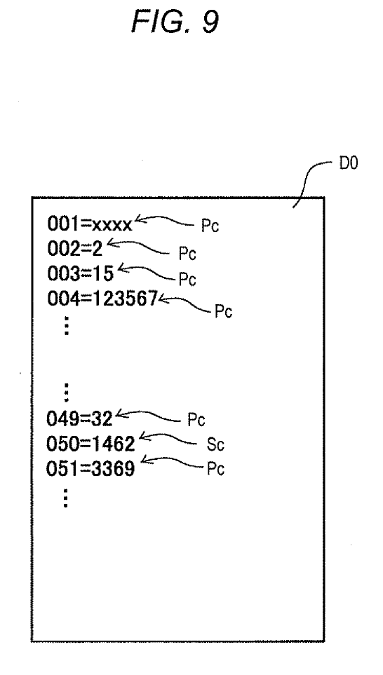

FIG. 9 is a diagram showing an example of the contents of the setup file D0. As shown in FIG. 9, in the setup file D0, a plurality of setup parameters Pc are recorded in association with a plurality of setup items (“001”, “002”, . . . ). Further, similarly to a plurality of setup parameters Pc, in the setup file D0, a security code Sc is recorded in association with a predetermined setup item (in the example of FIG. 9, “050”).

As described above, the security code Sc is recorded in the setup file D0, together with a plurality of setup parameters Pc, such that the security code Sc can be mingled with a plurality of setup parameters Pc. Thus, it is possible to make a third party who illegally obtains the memory card 9 unlikely to grasp the presence of the security code Sc itself. Further, even when the presence of the security code Sc is known, since the security code Sc and the setup parameters Pc are recorded in the same format, it is possible to make the third party unlikely to specify any code as the security code Sc.

<1-6. Data Recording Processing>

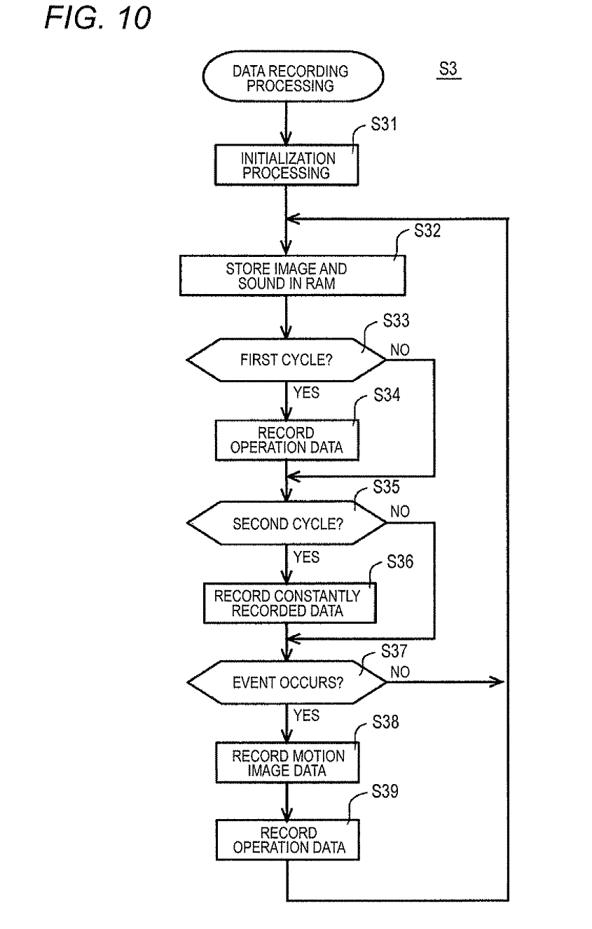

Next, the data recording processing (Step S3 of FIG. 4) will be described in which the drive recorder 2 records various kinds of data in the memory card 9 subjected to the recording preparation processing. FIG. 10 is a diagram showing a flow of the data recording processing. At the time of the starts of this operation, it is assumed that the memory card 9 in which the security code is recorded by the recording preparation processing is loaded into the card slot 26.

If the drive recorder 2 is activated, initialization processing is carried out under the control of the CPU 21 (Step S31). Specifically, first, it is confirmed whether there is a file D1 of operation data in the memory card 9 or not.

If there is no file D1 of operation data in the memory card 9, it is determined that the operation starts, and the folders F1 to F4 are created in the memory card 9 in which four kinds of data including operation data, motion image data, sound data, and constantly recorded data are respectively stored. Then, a file D1 of operation data is newly created in the “operation data” folder F1.

Various setup parameters of the setup file D0 in the memory card 9 are read and stored in the nonvolatile memory 25, and the drive recorder 2 is set in accordance with the setup parameters. At this time, the security code recorded in the setup file D0 is neglected.

At the time of the activation, if there is the file D1 of operation data in the memory card 9, it is determined as reactivation in the course of the operation, and creation of the file D1 of operation data and setting of the drive recorder 2 are omitted.

If the initialization processing is completed, image data obtained by the first camera 31 or the second camera 32 and sound data acquired by the microphone 33 start to be stored in the areas of the ring buffer of the RAM 24 (Step S32). Image data is stored in the RAM 24 at a frame rate of 30 fps (30 frames per second), for example. Subsequently, operation data, image data, and constantly recorded data are recorded in the memory card 9 under a predetermined condition (Steps S33, S35, and S37). Storing (Step S32) of image data and sound data in the RAM 24 is carried out until the drive recorder 2 stops during the activation of the drive recorder 2.

In Step S33, it is determined whether a predetermined first cycle in which operation data should be recorded is reached or not. If the first cycle is reached, operation data is recorded in the memory card 9 (Step S34). Thus, operation data is recorded in the memory card 9 for every ten seconds, for example. Operation data includes the position, speed, acceleration, and the like of the vehicle 13 at that point of time. Position information obtained by the GPS receiving section 29 is used as the position of the vehicle B, a traveling speed obtained by the vehicle speed sensor 41 is used as the speed of the vehicle B, and an acceleration obtained by the acceleration sensor 28 is used as the acceleration. Preferably, operation data includes various kinds of information regarding the operation or traveling of the vehicle B, such as the open/closed state of the door obtained by the door sensor 42, the operation situation of the recording switch 34, the lighting states of the lamps of the vehicle B, and the steering angle of the handle, in addition to the position, speed, and acceleration of the vehicle B.

In Step S35, it is determined whether a predetermined second cycle in which constantly recorded data should be recorded is reached or not. If the second cycle is reached, constantly recorded data is recorded in the memory card 9 (Step S36). Thus, constantly recorded data including image data and sound data is recorded in the memory card 9 for every one second, for example. As image data of constantly recorded data, single latest image data from among image data stored in the ring buffer of the RAM 24 is used. Therefore, the frame rate of image data of the constantly recorded data becomes 1 fps (1 frame per second).

In Step S37, it is determined whether a predetermined event occurs. When a predetermined event occurs, for example, image data and sound data for 12 seconds before the event occurs and 8 seconds after the event occurs, that is, for 20 seconds in total are read from the ring buffer of the RAM 24. Then, read image and sound data are used to generate single motion image data, and generated motion image data is recorded in the memory card 9 (Step S38). Further, operation data representing the situation of the vehicle B, such as the position, speed, and acceleration of the vehicle B, at the time of the occurrence of the event is recorded in the memory card 9 (Step S39).

In the drive recorder 2 of this embodiment, the conditions on which it is determined that a predetermined event occurs include the following conditions (A) to (D).

(A) when the acceleration sensor 28 continuously detects an acceleration equal to or higher than a predetermined value for a predetermined time or more. For example, when an acceleration equal to or higher 0.40 G is continuously detected for 100 milliseconds or more.

(B) when the speed difference within a predetermined period of the vehicle B detected by the vehicle speed sensor 41 is equal to or greater than a threshold value. For example, when a deceleration for one second is equal to or higher than 14 km/h during traveling at a speed equal to or higher than 60 km/h.

(C) when the recording switch 34 is operated by the user.

(D) when the door sensor 42 detects the opening of the door.

The condition (A) refers to a situation where a comparatively high acceleration is generated and there is a high probability of occurrence of a collision accident of the vehicle B. The condition (B) refers to a situation where rapid deceleration is made and there is a high probability that an accident becomes urgent. The condition (C) refers to a situation where the user (mainly, the driver of the vehicle B) determines that data recording is required. The condition (D) refers to a situation where trouble is likely to occur and a passenger gets into or out.

The event occurrence conditions, such as the conditions (A) to (D), are just an example and may be arbitrarily changed by using the data display device 1. Further, sound data, instead of motion image data, may be recorded in accordance with the type of an occurred event. For example, under the condition (D), only sound data may be recorded. When any event occurs, which of motion image data and sound data is recorded may be arbitrarily set by using the data display device 1.

<1-7. Data Latch Processing>

Next, the data latch processing (Step S5 of FIG. 4) will be described in which the data display device 1 reads data of the memory card 9 recorded by the drive recorder 2 and stores data in the hard disk 14. During this processing, code authentication using a security code is carried out. That is, the security code recorded in the memory card 9 is confirmed, and only when the security code coincides with a set security code, data is read from the memory card 9.

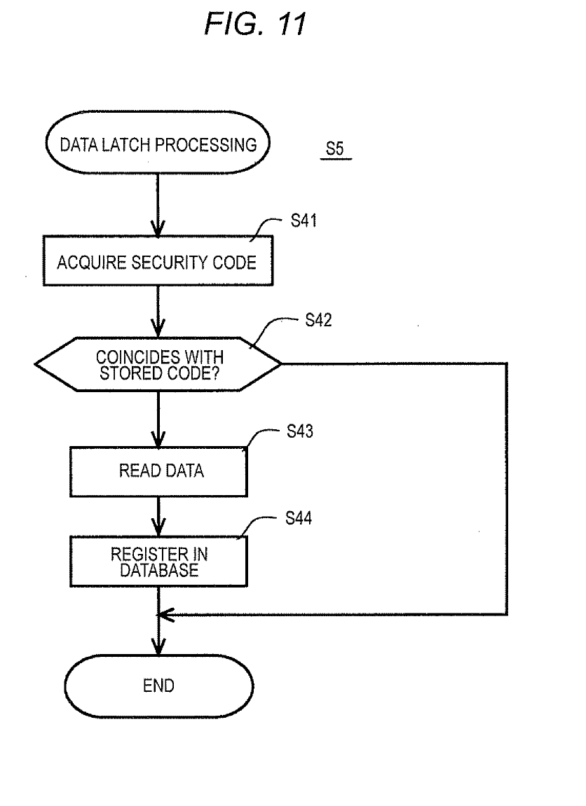

FIG. 11 is a diagram showing a flow of the data latch processing. This processing is carried out by activating the exclusive-use application, which handles data recorded in the drive recorder 2, on the data display device 1 and carrying out a predetermined operation. At the time of the start of this processing, it is assumed that the memory card 9 is loaded into the card slot 18.

First, the security code is read and acquired from the setup file D0 recorded in the memory card 9 (Step S41). Subsequently, the security code set by the user is read from the hard disk 14, and the security code acquired from the memory card 9 and the security code acquired from the hard disk 14 are compared with each other.

As a result of the comparison, when the two security codes coincide with each other (Yes in Step S42), operation data, motion image data, sound data, constantly recorded data, and the like stored in the memory card 9 are read (Step S43). Then, read data is converted in a format appropriate for registration and then registered in the database 142 of the hard disk 14 (Step S44). Data read as described above can be displayed on the display 15 as an image or output from the speaker 16 as sound.

Meanwhile, when the two security codes do not coincide with each other or when the security code cannot be acquired from the memory card 9 (No in Step S42), data reading is not carried out, and the data latch processing ends. With this processing, even when the third party illegally obtains the memory card 9, if the third party does not know the correct security code, data recorded by the drive recorder 2 cannot be displayed on the display 15 as an image or output from the speaker 16 as sound. As a result, the third party cannot confirm the contents of data recorded in the memory card 9, such that data leakage can be effectively prevented.

As described above, in the data display device 1 of this embodiment, the security code set by the user is stored in the hard disk 14, and also recorded in the memory card 9 in which data is recorded by the drive recorder 2. During the data latch processing, when the security code recorded in the memory card 9 coincides with the security code stored in the hard disk 14, data recorded in the memory card 9 can be read and displayed on the display 15. For this reason, if the security code is not known, data recorded in the memory card 9 cannot be displayed, thus data recorded by the drive recorder 2 can be effectively prevented from leaking.

During the recording preparation processing, the security code is recorded in the setup file D0 of the memory card 9, and during the data latch processing, the security code is acquired from the setup file D0. Thus, the drive recorder 2 can record data in the memory card 9 in which the security code is recorded, as usual without requiring special processing in the drive recorder 2. For this reason, the drive recorder 2 does not need to be upgraded so as to ensure security, such that data leakage can be prevented at comparatively low cost. Therefore, even the drive recorder which is known in the related art can be used as the drive recorder 2 of this embodiment. In a company which carries out operations by using a plurality of vehicles for commercial use, the type of the drive recorder to be mounted may differ between the vehicles, and a new type and an old type may be mixed. In such a case, the method of this embodiment can be suitably applied to effectively prevent data leakage.

The security code is recorded in the setup file D0, together with a plurality of setup parameters. Therefore, the security code can be mingled with other setup parameters, such that the presence of the security code can be hidden.

The security code may be recorded in an exclusive-use file of the memory card 9, instead of the setup file D0. In this case, the attribute of the exclusive-use file is preferably set as “hidden file”.

### 2. Second Embodiment

Next, a second embodiment will be described. Although in the first embodiment, the security code is recorded in the setup file D0, in the second embodiment, the security code is embedded in each piece of data recorded in the memory card 9. The configuration of a data display device 1 and a drive recorder 2 of the second embodiment is the same as that in the first embodiment, but the operations are partially different from those in the first embodiment. Therefore, the following description will be provided focusing on the difference from the first embodiment.

First, data recording processing (Step S3 of FIG. 4) by the drive recorder 2 of the second embodiment will be described. Recording preparation processing of the second embodiment is the same as that in the first embodiment.

The outline of the flow of data recording processing of the second embodiment is substantially the same as the flow of data recording processing of the first embodiment shown in FIG. 10, thus description will be provided with reference to FIG. 10.

First, the drive recorder 2 is activated to carry out initialization processing (Step S31). Specifically, if there is no file D1 of operation data in the memory card 9, the file D1 of operation data is created, and various setup parameters of the setup file D0 in the memory card 9 are read to set the drive recorder 2.

At this time, the security code recorded in the setup file D0 is read together with the setup parameters and stored in the nonvolatile memory 25. If the security code is read, the security code recorded in the setup file D0 of the memory card 9 is deleted. Thus, it is possible to make the third party unlikely to grasp the presence of the security code itself.

If the initialization processing is completed, image data obtained by the first camera 31 or the second camera 32 and sound data acquired by the microphone 33 start to be stored in the areas of the ring buffer of the RAM 24 (Step S32). Subsequently, under a predetermined condition (Steps S33, S35, and S37), operation data, image data, sound data, constantly recorded data, and the like are recorded in the memory card 9 (Steps S34, S36, S38, and S39).

In the drive recorder 2 of the second embodiment, when a file of such data is newly created in the memory card 9, the security code is embedded in a predetermined region of the relevant file. As the security code, the security code which is stored in the nonvolatile memory 25 during the initialization processing is used.

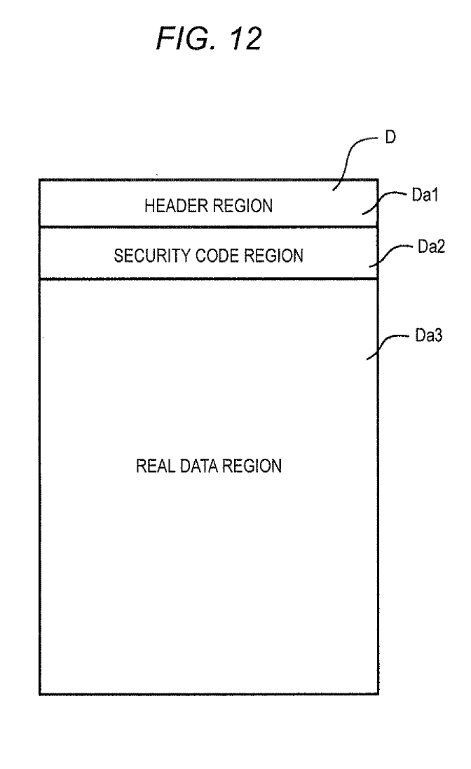

FIG. 12 is a diagram showing an example of data regions in a file D of data recorded by the drive recorder 2 of the second embodiment. As shown in FIG. 12, the file D of data has a security code region Da2 between a header region Da1 and a real data region Da3. The security code is embedded in the security code region Da2. The security code is preferably recorded in a binary format. The files of all of data recorded in the memory card 9 by the drive recorder 2 are embedded with the security codes, as shown in FIG. 12.

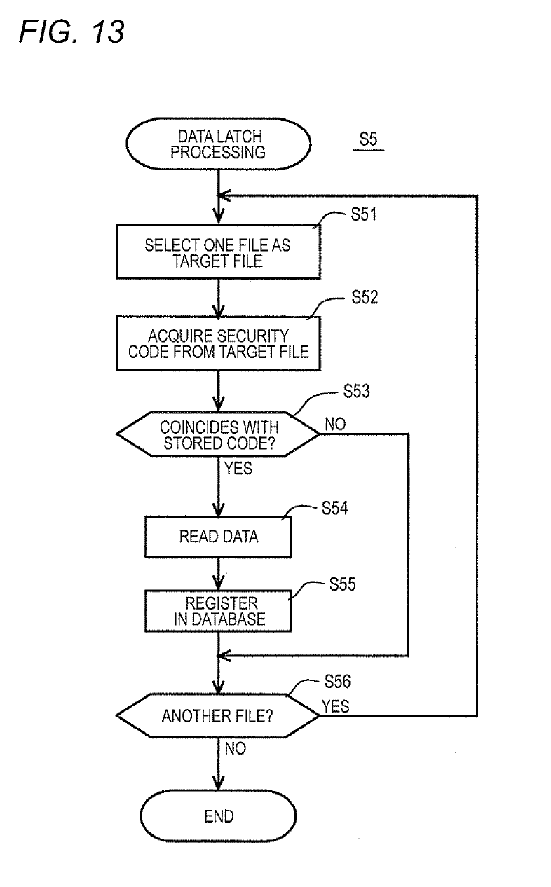

Next, data latch processing (Step S5 of FIG. 4) by the data display device 1 of the second embodiment will be described. FIG. 13 is a diagram showing a flow of data latch processing of the second embodiment.

During this processing, code authentication using a security code is also carried out. At this time, if the processing is normally carried out for the loaded memory card 9 by the drive recorder 2, the security code of the setup file D0 in the memory card 9 is deleted. For this reason, the security code of each file, instead of the security code in the setup file D0, is acquired.

First, one file from among the files registered in the memory card 9 is selected as a target file to be read (Step S51). Next, the security code region Da2 of the target file in the memory card 9 is read, and the security code embedded in the target file is acquired (Step S52).

Subsequently, the security code set by the user is read from the hard disk 14, and the security code acquired from the target file and the security code acquired from the hard disk 14 are compared with each other.

As a result of the comparison, when the two security codes coincide with each other (Yes in Step S53), the target file is read from the memory card 9 (Step S54), converted in a format appropriate for registration, and registered in the database 142 of the hard disk 14 (Step S55).

Meanwhile, when the two security codes do not coincide with each other or when the security code cannot be acquired from the target file (No in Step S53), reading of the target file is not carried out.

In this way, if the processing regarding one file is completed, it is determined whether there is an unprocessed file, which is not selected as a target file, in the memory card 9 (Step S56). When there is an unprocessed file (Yes in Step S56), the next file is selected as a new target file (Step S51), reading is carried out in accordance with the embedded security code. Such processing is repeatedly carried out, and finally all of the files in the memory card 9 are processed, such that only the files whose embedded security code coincides with the set security code are read.

As described above, according to the second embodiment, the security code is embedded in the file of each piece of data recorded in the memory card 9 by the drive recorder 2, and the data display device 1 acquires the embedded security code from the file of data to be read in the memory card 9 with data having been recorded therein. Then, only when the embedded security code coincides with the set security code, the file of relevant data can be read and displayed on the display 15. For this reason, data leakage can be prevented individually in units of files of data, not in units of the memory card 9. Further, the security code is embedded in the file of data, it is possible to make the third party who illegally obtains the memory card 9 unlikely to grasp the presence of the security code itself.

### 3. Third Embodiment

Next, a third embodiment will be described. In the first and second embodiments, no special processing is carried out for the security code itself when the data display device 1 records the security code in the memory card 9. In contrast, in the third embodiment, the data display device 1 encrypts the security code and then records the encrypted security code in the memory card 9.

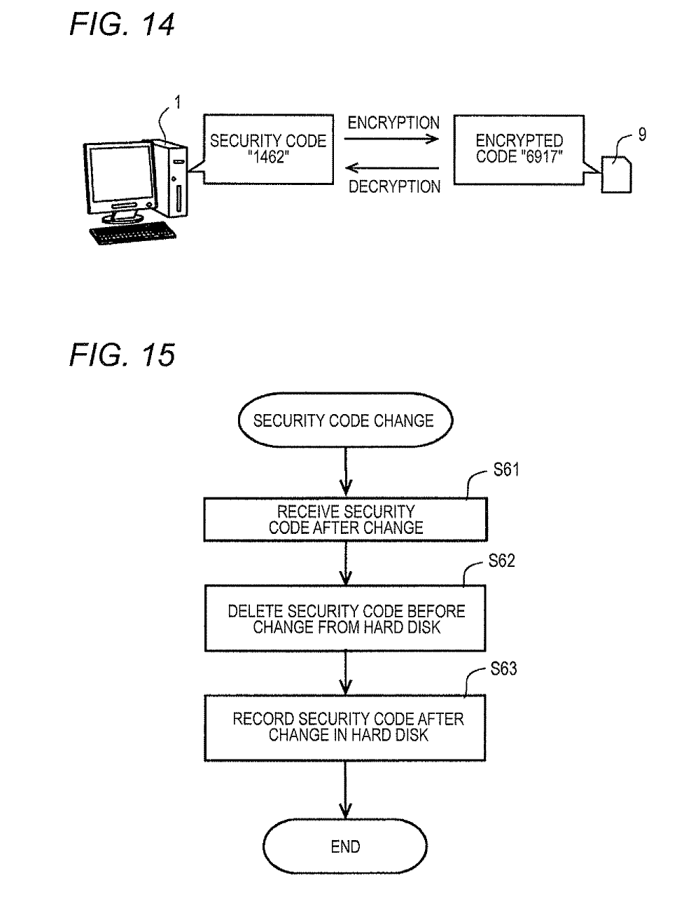

FIG. 14 is a diagram illustrating the concept when a security code is encrypted. FIG. 14 shows an example where, when the data display device 1 sets the security code, the user sets four digits of “1462”. In this case, “1462” is recorded in the hard disk 14 as the security code.

Meanwhile, during the recording preparation processing, when the security code is recorded in the memory card 9, the security code is encrypted and then recorded. As the encryption method, various known methods may be used. Simply, a predetermined arithmetic operation may be carried out by using the four numerals of the security code, and the result may be set as the encrypted security code (hereinafter, “encrypted code”).

For example, “5” may be respectively added to the four numerals of the security code, and the first digits of the results may be arranged and set as an encrypted code. In the example of FIG. 14, since the security code is “1462”, the encrypted code becomes “6917”. Thus, “6917” is recorded in the memory card 9.

The encrypted code recorded in the memory card 9 as described above may be handled same as the security code recorded in the memory card 9 in the first and second embodiments. The processing of the drive recorder 2 is the same as that in the first and second embodiments.

During the data latch processing by the data display device 1, the encrypted code is read from the recorded contents of the memory card 9, and the encrypted code is decrypted to acquire the security code. The decryption method is the reverse conversion of the encryption method. That is, a reverse arithmetic operation of the arithmetic operation at the time of encryption is carried out for the encrypted code, such that the security code can be decrypted. For example, when the above-described encryption method is used in which “5” is added, “5” is respectively subtracted from the four numerals of the encrypted code, such that the security code can be decrypted. In the example of FIG. 14, since the encrypted code is “6917”, the security code can be decrypted as “1462”. Then, the decrypted security code may be compared with the security code recorded in the hard disk 14.

As described above, according to the third embodiment, during the recording preparation processing, the security code is encrypted and recorded in the memory card 9. Further, during the data latch processing, the encrypted code acquired from the recorded contents of the memory card 9 with data having been recorded therein is decrypted, such that the security code is obtained. For this reason, even when the third party illegally obtains the memory card 9 and finds out the presence of the security code, it is very difficult for the third party to grasp the contents of the security code itself. Therefore, data leakage can be further effectively prevented.

In the above-described embodiment, the encrypted code acquired from the recorded contents of the memory card 9 with data having been recorded therein is decrypted. In contrast, the encryption result of the security code recorded in the hard disk 14 and the encrypted security code obtained from the memory card 9 may be compared with each other.

### 4. Fourth Embodiment

Next, a fourth embodiment will be described. The configuration and processing of a data display device 1 and a drive recorder 2 of the fourth embodiment are substantially the same as those in the first embodiment. However, in the fourth embodiment, the security code can be appropriately changed in the data display device 1.

FIG. 15 is a diagram showing a flow of processing when a security code is changed in the data display device 1 of the fourth embodiment. This processing is carried out by activating the exclusive-use application, which handles data recorded in the drive recorder 2, on the data display device 1 and carrying out a predetermined operation.

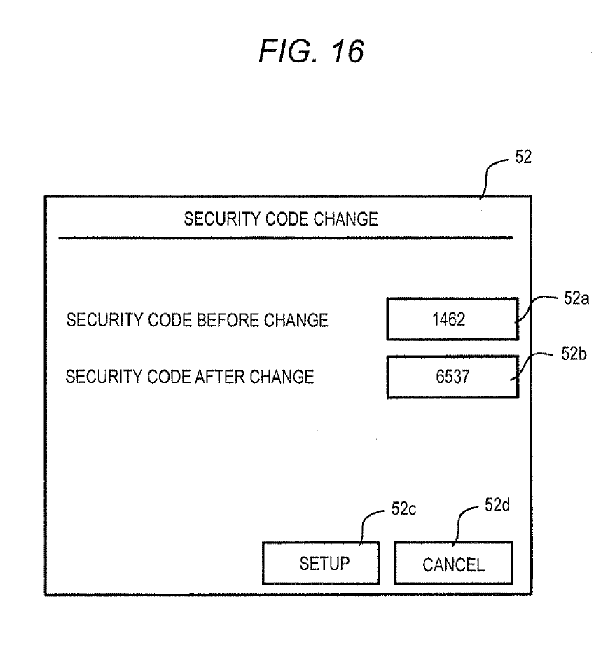

First, a change dialogue for receiving a change of a security code is displayed on the display 15. FIG. 16 is a diagram showing an example of a change dialogue 52. In the change dialogue 52, two text boxes 52a and 52b, a setup button 52c, and a cancel button 52d are arranged.

The user respectively inputs a security code before change and a security code after change in the upper and lower text boxes 52a and 52b of the change dialogue 52, and clicks the setup button 52c. When the security code input in the upper text box 52a coincides with the security code stored in the hard disk 14, four digits of numerals input in the lower text box 52b are received by the CPU 11 as a security code after change (Step S61).

Then, the security code before change is deleted from the hard disk 14 (Step S62), and the security code after change is recorded in the hard disk 14 (Step S63). Thus, only the security code after change is recorded in the hard disk 14. When the cancel button 52d of the change dialogue 52 is clicked, the processing ends, and the previous security code remains unchanged.

When the security code is changed as described above, during the subsequent recording preparation processing and data latch processing in the data display device 1, the security code after change is used. However, there may be a situation where the memory card 9 subjected to the recording preparation processing before the security code is changed will be subject to the data latch processing after the security code is changed. In this case, since the security code before change is recorded in the memory card 9, data reading may not be carried out. In order to solve such a problem, during the data latch processing of the fourth embodiment, an input of a security code from the user is received.

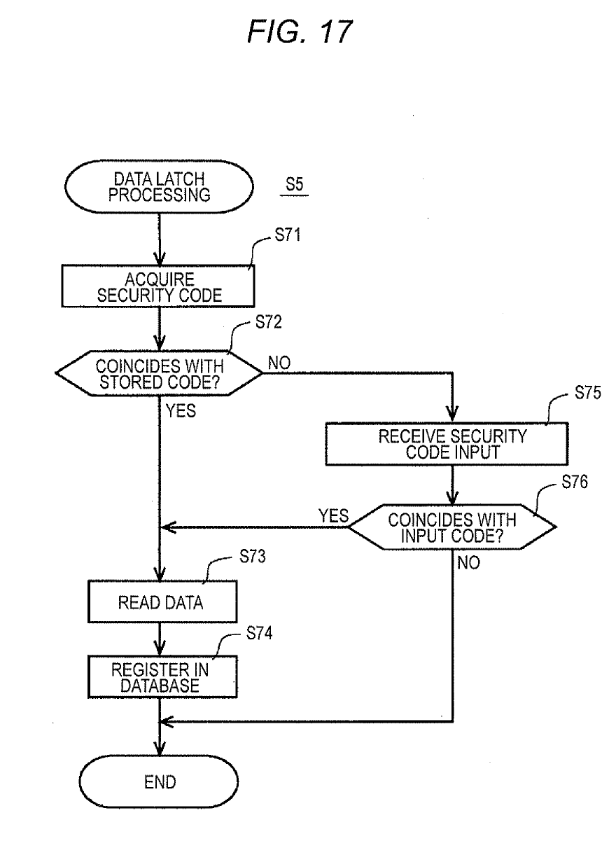

FIG. 17 is a diagram showing a flow of data latch processing of the fourth embodiment. First, the security code is read and acquired from the setup file D0 recorded in the memory card 9 (Step S71). Subsequently, the security code set by the user is read from the hard disk 14. The security code is the latest security code which is changed recently. Then, the security code acquired from the memory card 9 and the security code acquired from the hard disk 14 are compared with each other.

When the two security codes coincide with each other (Yes in Step S72), similarly to the first embodiment, data is read from the memory card 9 (Step S73) and registered in the database 142 of the hard disk 14 (Step S74).

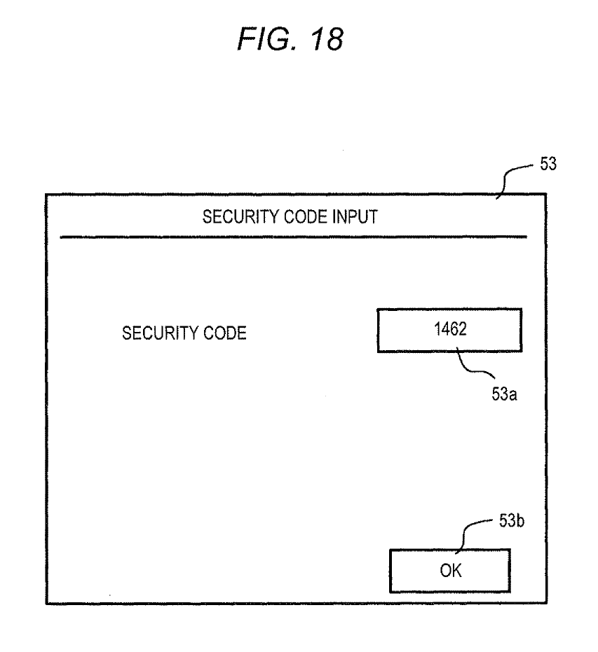

Meanwhile, when the two security codes do not coincide with each other (No in Step S72), first, the indication is notified to the user, and an input dialogue for receiving an input of a security code from the user is displayed on the display 15. FIG. 18 is a diagram showing an example of an input dialogue 53. In the input dialogue 53, a text box 53a and an OK button 53b are arranged.

The user inputs the security code before change, which he/she keeps in mind, in the text box 53a of the input dialogue 53 and then clicks the OK button 53b. Thus, the security code input in the text box 53a is received by the CPU 11 (Step S75).

Subsequently, the security code acquired from the memory card 9 and the security code input from the user are compared with each other. Then, when the security codes coincide with each other (Yes in Step S76), data is read from the memory card 9 {Step S73) and registered in the database 142 of the hard disk 14 (Step S74). Meanwhile, when the security codes do not coincide with each other (No in Step S76), data reading is not carried out, and the data latch processing ends.

As described above, according to the fourth embodiment, the security code can be appropriately changed, thus the security code is changed regularly, such that data leakage can be further effectively prevented.

When the security code acquired from the memory card 9 and the security code stored in the hard disk 14 do not coincide with each other, an input of a security code is received from the user. For this reason, even when the security code is changed, if the security code before change is kept in mind, data reading can be carried out from the memory card 9 which is subjected to the recording preparation processing before the security code is changed.

In the above-described embodiment, during the data latch processing same as the first embodiment shown in FIG. 11, when the security codes do not coincide with each other, the processing for receiving an input of a security code from the user is further provided. In contrast, during the data latch processing shown in FIG. 13 same as the second embodiment, when the security codes do not coincide with each other, the processing for receiving an input of a security code from the user may be further provided.

In the above-described embodiment, when the security code acquired from the memory card 9 and the security code stored in the hard disk 14 do not coincide with each other, an input of a security code is received from the user. In contrast, an input of a security code may be received from the user every time with no comparison with the security code stored in the hard disk 14. In this case, the security code may not be stored in the hard disk 14.

### 5. Fifth Embodiment

Next, a fifth embodiment will be described. In the fourth embodiment, the user keeps the security code before change in mind and inputs the security code before change, such that data of the memory card 9 in which the security code before change is recorded can be read. In contrast, in the fifth embodiment, both of the security code before change and the security code after change are stored in the hard disk 14 of the data display device 1.

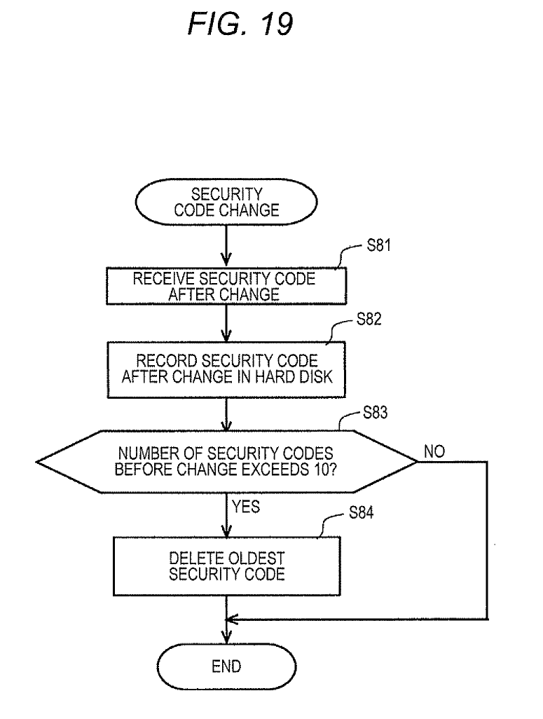

FIG. 19 is a diagram showing a flow of processing when a security code is changed in the data display device 1 of the fifth embodiment. This processing is carried out by activating the exclusive-use application, which handles data recorded in the drive recorder 2, on the data display device 1 and carrying out a predetermined operation.

First, a change dialogue 52 (see FIG. 16) for receiving a change of a security code is displayed on the display 15. Then, the user respectively inputs the security code before change and the security code after change in the upper and lower text boxes 52a and 52b, and clicks the setup button 52c. When the security code input in the upper text box 52a coincides with the security code stored in the hard disk 14, four digits of numerals input in the lower text box 52b are received by the CPU 11 as the security code after change (Step S81). Then, the security code after change is recorded in the hard disk 14 (Step S82).

Meanwhile, the security code before change remains in the hard disk 14. For this reason, the previously used security codes before change are accumulated in the hard disk 14. However, when the number of security code before change exceeds a predetermined threshold value (for example, 10), the oldest security code is deleted from the hard disk (Steps S83 and S84). Thus, the number of security codes before change stored in the hard disk 14 is limited to a predetermined number (in this embodiment, 10).

During the data latch processing of the fifth embodiment, even when the security code acquired from the memory card 9 coincides with the security code before change stored in the hard disk 14 as described above, data recorded in the memory card 9 is read.

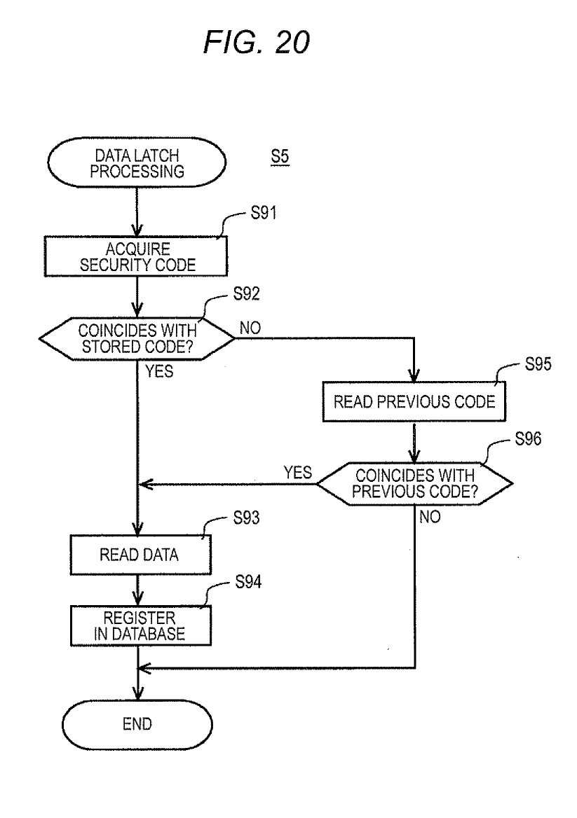

FIG. 20 is a diagram showing a flow of data latch processing of the fifth embodiment. First, the security code is read and acquired from the setup file D0 recorded in the memory card 9 (Step S91). Subsequently, the security code set by the user is read from the hard disk 14. The security code is the latest security code which is changed recently. Then, the security code acquired from the memory card 9 and the security code acquired from the hard disk 14 are compared with each other.

When the two security codes coincide with each other (Yes in Step S92), similarly to the first embodiment, data is read from the memory card 9 (Step S93) and registered in the database 142 of the hard disk 14 (Step S94).

Meanwhile, when the two security codes do not coincide with each other (No in Step S92), all of the previously used security codes before change which are stored in the hard disk 14 are read and acquired. The number of security code before change may be a single number or a plural number, and the number is limited to a predetermined number (in this embodiment, 10) (Step S95).

Subsequently, the security code acquired from the memory card 9 and all of the previously used security codes before change are compared with each other. Then, when the security code acquired from the memory card 9 coincides with one of the previously used security codes before change (Yes in Step S96), data is read from the memory card 9 (Step S93) and registered in the database 142 of the hard disk 14 (Step S94).

Meanwhile, when the security code acquired from the memory card 9 does not coincide with any one of the previously used security codes before change (No in Step S96), data reading is not carried out, and the data latch processing ends.

As described above, according to the fifth embodiment, the change of the security code is received from the user, and the security code before change and the security code after change are stored in the hard disk 14. Then, during the data latch processing, even when the security code acquired from the memory card 9 and the security code before change stored in the hard disk 14 coincide with each other, data recorded in the memory card 9 is read. For this reason, even when the security code is changed, data can be read from the memory card 9 which is subjected to the recording preparation processing before the security code is changed, without carrying out special processing.

However, if the number of security codes before change for use in comparison with the security code acquired from the memory card 9 is not limited, the possibility of data leakage due to accidental coincidence or the like increases. In contrast, according to the fifth embodiment, the number of security codes before change for use in comparison with the security code acquired from the memory card 9 is limited to a predetermined number (in this embodiment, 10), such that the possibility of data leakage can be reduced.

Although in the above-described embodiment, the number of security codes stored in the hard disk 14 is limited, the number of security codes to be read in Step S95 may be limited or the number of security codes to be compared in Step S96 may be limited.

In the above-described embodiment, when the security code acquired from the memory card 9 and the security code before change stored in the hard disk 14 do not coincide with each other, similarly to the fourth embodiment, an input of a security code may be received from the user.

In the above-described embodiment, during the data latch processing same as the first embodiment shown in FIG. 11, when the security codes do not coincide with each other, the processing for comparing with the security code before change is further provided. In contrast, during the data latch processing same as the second embodiment shown in FIG. 13, when the security codes do not coincide with each other, the processing for comparing with the security code before change may be further provided.

### 6. Modifications

Although the embodiments of the invention have been described, the invention is not limited to the foregoing embodiments, and various modifications may be made. Hereinafter, such modifications will be described. All of the embodiments including the foregoing embodiments and the following embodiments may be appropriately combined with each other.

Although in the foregoing embodiments, the security code is constituted by four digits of numerals, the invention is not limited thereto. For example, the security code may be constituted by other digits of numerals. Further, the security code may not include only numerals but may be constituted by arbitrarily combining numerals, characters, symbols, and the like.

In the foregoing embodiments, the application reads data recorded in the memory card 9 and registers data in the hard disk 14, such that data can be displayed on the display 15. In contrast, an application may be used which directly reads data recorded in the memory card 9 and displays data on the display 15. In this case, code authentication using the same security code as that in the foregoing embodiment may be carried out before data is read or before data is displayed on the display 15.

The drive recorder 2 may encrypt data recorded in the memory card 9 by using the security code. In this case, during the data latch processing of the data display device 1, data read from the memory card 9 may be decrypted by using the security code stored in the hard disk 14. However, if such a configuration is used, an algorithm at the time of recording by the drive recorder 2 is complicated, and the promptness or reliability of recording by the drive recorder 2 may be deteriorated. In an emergency, such as a vehicle accident, in order to reliably exhibit the original function of the drive recorder 2 to record image data and the like in the memory card 9, similarly to the foregoing embodiments, preferably, unencrypted data is simply recorded in the memory card 9.

Although in the foregoing embodiments, a case has been described where the drive recorder system 100 is applied to a company which carries out operations by using taxis, the invention may be applied to any company insofar as the company carries out operations by using a plurality of vehicles for commercial user, such as trucks, buses, and commercial vehicles.

With regard to a drive recorder system for a general customer, not commercial use, the technique described in the foregoing embodiment may be applied. Such a drive recorder system includes a data display device which is constituted by a general personal computer or the like, and a drive recorder which is customized for a general customer.

Although in the foregoing embodiments, a case has been described where the memory card 9 is used as a portable recording medium, a recording disk, such as a readable/writable CD-ROM, a portable hard disk, or the like may be used.

Although in the foregoing embodiments, a case has been described where various functions are implemented by software through the arithmetic processing of the CPU in accordance with the program, some of the functions may be implemented by electrical hardware circuits.

What is claimed is:

1. A display device that displays data recorded in a portable recording medium by a drive recorder on a display unit, the display device comprising:
a code recording unit that records a security code in the recording medium in which data is recorded by the drive recorder;
a nonvolatile storage device that stores a security code which is the same as the security code for use at the time of recording in the recording medium;
a code acquisition unit that acquires the security code from recorded contents of the recording medium in which the data is recorded by the drive recorder; and
a code authentication unit that enables the display unit to display the data recorded in the recording medium when the security code acquired from the recording medium coincides with the security code stored in the storage device.

2. The display device as set forth in claim 1,
wherein the code recording unit records the security code in a predetermined file, and
wherein the code acquisition unit acquires the security code from the predetermined file of the recording medium.

3. The display device as set forth in claim 2, wherein the predetermined file is a setup file in which a plurality of setup parameters of the drive recorder are recorded.

4. The display device as set forth in claim 1,
wherein the drive recorder embeds the security code in each piece of data recorded in the recording medium, and
wherein the code acquisition unit acquires the security code from data to be read in the recording medium in which the data is recorded.

5. The display device as set forth in claim 1, wherein the code recording unit encrypts the security code and records the encrypted security code in the recording medium.

6. The display device as set forth in claim 5, wherein the code acquisition unit decrypts the encrypted security code acquired from the recorded contents of the recording medium in which the data is recorded.

7. The display device as set forth in claim 1, further comprising a recording unit that receives a change of the security code from a user and stores both a security code before change and a security code after change in the storage device,
wherein the code authentication unit enables the display unit to display the data recorded in the recording medium even when the security code acquired from the recording medium coincides with the security code before change stored in the storage device.

8. The display device as set forth in claim 7, wherein the number of security codes before change for use in comparison with the security code acquired from the recording medium by the code authentication unit is limited to a predetermined number.

9. The display device as set forth in claim 1, further comprising a receiving unit that receives an input of a security code by the user when the security code acquired from the recording medium does not coincide with the security code stored in the storage device,
wherein the code authentication unit enables the display unit to display the data recorded in the recording medium even when the security code acquired from the recording medium coincides with the security code received by the receiving unit.

10. A drive recorder to be mounted in a vehicle, that records data regarding traveling of the vehicle in a portable recording medium, the drive recorder comprising:
a reading unit that reads a security code from the recording medium in which the security code is recorded; and
an embedding unit that embeds the read security code in each piece of data to be recorded in the recording medium.

11. The drive recorder as set forth in claim 10, further comprising a deletion unit that deletes the security code from the recording medium after the reading unit reads the security code from the recording medium.

12. A method of displaying data recorded in a portable recording medium by a drive recorder on a display unit, the method comprising;
recording a security code in the recording medium in which data is recorded by the drive recorder;
storing a security code which is the same as the security code for use at the time of recording in the recording medium in a nonvolatile storage device;
acquiring the security code from recorded contents of the recording medium in which the data is recorded by the drive recorder; and
enabling the display unit to display the data recorded in the recording medium when the security code acquired from the recording medium coincides with the security code stored in the storage device.

13. A computer-readable medium recording a program causing a computer to execute the method as set forth in claim 12.
